(19) United States
(12) Patent Application Publication
(10) Pub. No.: US 2019/0268665 A1
(43) Pub. Date: Aug. 29, 2019

(54) ELECTRONIC DEVICE, BROADCAST SERVICE PROVIDING SYSTEM, AND OPERATION METHOD THEREFOR

(71) Applicant: SAMSUNG ELECTRONICS CO., LTD., Suwon-si, Gyeonggi-do (KR)

(72) Inventors: Kwan-sik YANG, Suwon-si, Gyeonggi-do (KR); Myung-jin EOM, Seoul (KR); Kwang-soo JUNG, Gwacheon-si, Gyeonggi-do (KR)

(21) Appl. No.: 16/345,814

(22) PCT Filed: Jun. 9, 2017
(86) PCT No.: PCT/KR2017/006014

§ 371 Date: Apr. 29, 2019

(30) Foreign Application Priority Data
Oct. 28, 2016 (KR) 10-2016-0142146

(51) Int. Cl. H04N 21/485; H04N 21/266; H04N 21/254; H04N 21/258

(52) U.S. Cl. CPC H04N 21/485; H04N 21/25841; H04N 21/2541; H04N 21/266

(57) ABSTRACT

Provided are an electronic device, a broadcast service providing system, and an operation method therefor of the electronic device. The electronic device includes a communicator; a memory for storing one or more instructions; and a processor for executing one or more instructions stored in the memory, wherein, by executing one or more instructions, the processor: receives identification information of one or more broadcast service providers available for the electronic device from a broadcast service management server in response to transmission of information enabling position identification of the electronic device to the broadcast service management server via a network; displays a user interface including the received identification information; accesses a selected broadcast service provider server in response to a user input having selected one broadcast service provider on the basis of the identification information of the one or more broadcast service providers through the user interface; and receives and stores conditional reception system software from the broadcast service provider server.

### TECHNICAL FIELD

Various embodiments relate to an electronic device for providing a broadcast service using a downloadable conditional access system (DCAS), a broadcast service providing system, and an operation method of the electronic device.

### BACKGROUND ART

An Internet Protocol television (IPTV) service may be a representative service of a triple play service (TPS) that constitutes and provides broadcast, communication, and data services as one service system. In particular, it is expected that the IPTV service may meet the needs of various types of content consumption because the IPTV service may provide a real-time broadcast service as well as the existing content service on demand in an Internet environment. However, in order for a content service provider to stably supply a high-quality content service, a system is required to charge a subscriber a content usage fee and to control the use thereof. Technologies are generally applied in which content is transmitted in an encrypted state such that only a user having a legitimate use right may use paid content and only a subscriber having a use right for the content can decrypt and use the content. In a unidirectional content service such as digital satellite broadcasting, a conditional access system is used to protect paid content and control the use of content by users. Also, in an interactive content service such as a service on demand, a digital rights management (DRM) system is used for content protection and usage control.

A conditional access system (CAS) means a control system that does not provide programs to subscribers who do not subscribe to cable broadcasting in a system capable of providing programs such as a cable broadcast. The CAS may provide a variety of programs in a package in cooperation with a subscriber management system, or provide a program suitable for each subscriber, such as a video on demand (VOD) or pay per view (PPV) service.

In general, the CAS operates in conjunction with a cable card in a set-top box. However, the CAS is applied differently for each set-top box manufactured by each vendor, and there is a problem in dependency of a cable card supporting only a specific CAS, and another problem is that it is difficult to change the CAS in operation.

In order to solve these problems, a downloadable conditional access system (DCAS) has been proposed. The DCAS is an access authentication technology that allows a software-composed CAS to be downloaded directly to a set-top box to provide a paid service. There is an advantage to the DCAS in that a cable provider may freely update the CAS stored in the set-top box.

### DESCRIPTION OF EMBODIMENTS

### Technical Problem

Provided is a need for a broadcast service providing system capable of more effectively providing a broadcast service using a downloadable conditional access system (DCAS).

### Solution to Problem

According to an aspect of the present disclosure, various embodiments provide an electronic device for effectively providing a broadcast service when using a downloadable conditional access system (DCAS), a broadcast service providing system, and an operation method therefor.

### Advantageous Effects of Disclosure

According to the embodiments, a broadcast service management server may provide connections to servers of various broadcast providers, and thus a user may conveniently download conditional access system software corresponding to a plurality of broadcast providers.

According to the embodiments, the broadcast service management server may connect contents provided by various broadcast providers, and thus the user may conveniently use the contents provided by the multiple broadcast providers.

### BRIEF DESCRIPTION OF DRAWINGS

FIG. 1 is a reference diagram for explaining a concept of a broadcast service providing system according to embodiments.

FIG. 2 is a block diagram of a broadcast service management server according to an embodiment.

FIG. 3 illustrates a client device which is an example of a client according to an embodiment.

FIG. 4 illustrates a client device which is an example of the client according to an embodiment.

FIG. 5 is a flowchart illustrating an example of an operation in a broadcast service providing system according to an embodiment.

FIG. 6 illustrates an example of a user interface for accessing a broadcast service management server according to an embodiment.

FIG. 7 illustrates an example of a user interface for selecting a broadcast provider according to an embodiment.

FIG. 8 is a flowchart illustrating another example of an operation in a broadcast service providing system according to an embodiment.

FIG. 9 illustrates an example of a user interface for selecting a content policy according to an embodiment.

FIG. 10 is a flowchart illustrating another example of an operation in a broadcast service providing system according to an embodiment.

FIG. 11 illustrates an example of a user interface for selecting a plurality of broadcast providers according to an embodiment.

FIG. 12 illustrates an example of a billing process operation performed in a broadcast service management server according to an embodiment.

FIG. 13 illustrates an example of a user interface for selecting a broadcast provider according to an exemplary embodiment.

FIG. 14 illustrates an example of a content list of a broadcast provider according to an embodiment.

FIG. 15 illustrates an example of billing information about use of a broadcast service according to an embodiment.

FIG. 16 illustrates another example of a billing process operation performed in a broadcast service management server according to an embodiment.

FIG. 17 illustrates an example of billing information in consideration of advertisement viewing according to an embodiment.

FIG. 18 illustrates an example of a user interface for allowing a client to manage a plurality of broadcast providers according to an embodiment.

### BEST MODE

An electronic device may include a communicator; a memory storing one or more instructions; and a processor configured to execute the one or more instructions stored in the memory to: in response to transmitting information for identifying a location of the electronic device to a broadcast service management server over a network, receive identification information about one or more broadcast providers available to the electronic device from the broadcast service management server: display a user interface comprising the received identification information about the one or more broadcast providers, and receive a user input to select one broadcast provider from the identification information about the one or more broadcast providers through the user interface; and in response to the received user input, access the selected broadcast provider and receive conditional access system (CAS) software from the broadcast provider.

The processor may be further configured to: access the broadcast provider selected according to the user input; in response to receiving one or more content providing policies from the broadcast provider, display a user interface comprising the received one or more content providing policies; transmit a content providing policy selected from the one or more content providing policies to the broadcast provider through the user interface; and receive and store the CAS software corresponding to the selected content providing policy from the broadcast provider.

The processor may be further configured to: receive a user input to select another broadcast provider; in response to the received user input, access the selected other broadcast provider and receive and store other CAS software from the other broadcast provider.

The processor may be further configured to: when storing the other CAS software, remove previously stored CAS software.

The processor may be further configured to: when storing the other CAS software, store the other CAS software without removing the previously stored CAS software.

The processor may be further configured to: enable one of the stored CAS software and the other CAS software according to a user input to select a broadcast provider.

A system for providing a broadcast service may include a broadcast service management server configured to provide a client device with identification information about one or more broadcast providers available to the client device in correspondence to a location of the client device, and in response to a user input to select one of the one or more broadcast providers, provide the client device with information of the selected broadcast provider; the client device configured to send a request for conditional access system (CAS) software of the broadcast provider to the broadcast provider using the information of the broadcast provider received from the broadcast service management server and receive and store the conditional access system (CAS) software from the broadcast provider; and one or more broadcast providers configured to provide the CAS software to the client device upon request by the client device.

An operation method of an electronic device may include, in response to transmitting information for identifying a location of the electronic device to a broadcast service management server over a network, receiving identification information about one or more broadcast providers available to the electronic device from the broadcast service management server: displaying a user interface comprising the received identification information about the one or more broadcast providers and receiving a user input to select one broadcast provider from the identification information about the one or more broadcast providers through the user interface; and in response to the received user input, accessing the selected broadcast provider and receiving conditional access system (CAS) software from the broadcast provider.

### MODE OF DISCLOSURE

Hereinafter, terms that are used in the specification will be briefly described, and embodiments of the disclosure will be described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of embodiments. Thus, the terms used herein have to be defined based on the meaning of the terms together with the description throughout the specification.

Also, when a part “includes” or “comprises” an element, unless there is a particular description contrary thereto, the part may further include other elements, not excluding the other elements. In the following description, terms such as “unit” and “module” indicate a unit for processing at least one function or operation, wherein the unit and the block may be embodied as hardware or software or embodied by combining hardware and software.

The embodiments will now be described more fully with reference to the accompanying drawings. However, the embodiments may be embodied in many different forms, and should not be construed as being limited to the embodiments set forth herein. Rather, these embodiments are provided so that this disclosure will be thorough and complete, and will fully convey the concept of the embodiments to one of ordinary skill in the art. In the following description, well-known functions or constructions are not described in detail because they would obscure the embodiments with unnecessary detail, and like reference numerals in the drawings denote like or similar elements throughout the specification. As used herein, the term “and/or” includes any and all combinations of one or more of the associated listed items. Expressions such as “at least one of,” when preceding a list of elements, modify the entire list of elements and do not modify the individual elements of the list.

The term “user” in the present description means a person who controls a function or an operation of an image display apparatus by using a control device and may include a viewer, an administrator, or an installation engineer.

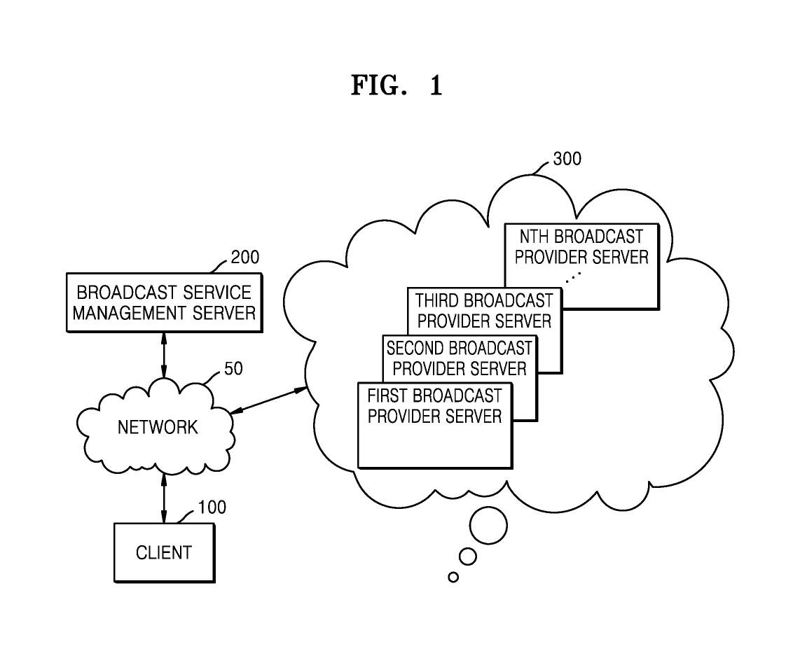

FIG. 1 is a reference diagram for explaining a concept of a broadcast service providing system according to embodiments.

Referring to FIG. 1, the broadcast service providing system may include a network 50, a client 100, a broadcast service management server 200, and a plurality of broadcast provider servers 300.

The network 50 represents one or more communication networks that enable communication between the broadcast service management server 200 and the client 100, communication between the broadcast service management server 200 and the broadcast provider server 300, and communication between the client 100 and the broadcast provider server 300.

The client 100 is an electronic device for receiving and displaying broadcast transmitted from a broadcast provider. A television is a typical example of the client 100, but any other terminal devices capable of performing communication and displaying a received broadcast signal are also possible.

In the related art, a client has used a broadcast service by using built-in conditional access system software or by directly accessing a broadcast provider server and downloading the conditional access system software from the broadcast provider server. However, the client 100 according to the present embodiments may easily receive the broadcast service from various broadcast provider servers by accessing the broadcast service management server 200 that manages the use of the broadcast service from the plurality of broadcast provider servers 300.

The client 100 may be a TV, but this is merely an example and may be implemented as an electronic device including a display. For example, the client 100 may be implemented as various electronic devices such as a mobile phone, a tablet PC, a digital camera, a camcorder, a laptop computer, a tablet PC, a desktop, an electronic book terminal, a digital broadcast terminal, a personal digital assistant (PDA), a portable multimedia player (PMP), a navigation device, an MP3 player, a wearable device, and the like. In particular, the embodiments may be easily implemented in a display device having a large display such as a TV, but is not limited thereto. Also, the client 100 may be a fixed type or a movable type, and may be a digital broadcast receiver capable of receiving digital broadcast.

In response to a request from the client 100, the broadcast service management server 200 may provide identification information of one or more broadcast provider servers available to the client 100 to the client 100, and may generally manage a billing service as the client 100 uses the broadcast service from the one or more broadcaster provider servers.

The broadcast provider servers 300 may include one or more broadcaster provider servers. Each broadcast provider server 300 may provide a broadcast service according to one or more policies. Each broadcast provider server 300 may encrypt broadcast contents according to an encryption protocol and broadcast the encrypted broadcast contents. Only the client 100 having conditional access system (CAS) software capable of encrypting such specific broadcast contents may decrypt and reproduce the encrypted broadcast contents.

As shown in FIG. 1, the client 100 may conveniently download the CAS software from the broadcast provider server 300 by accessing the broadcast service management server 200. Also, the broadcast service management server 200 may connect the client 100 with the plurality of broadcast provider servers 300 such that the client 100 may download the CAS software from the one or more broadcast provider servers 300. Also, because the broadcast service management server 200 may provide a function of collecting charges for broadcast services from the plurality of broadcast provider servers 300, the client 100 may be provided with a broadcast service from one broadcast provider server within a predetermined period and may also be provided with a broadcast service from a plurality of broadcast provider servers.

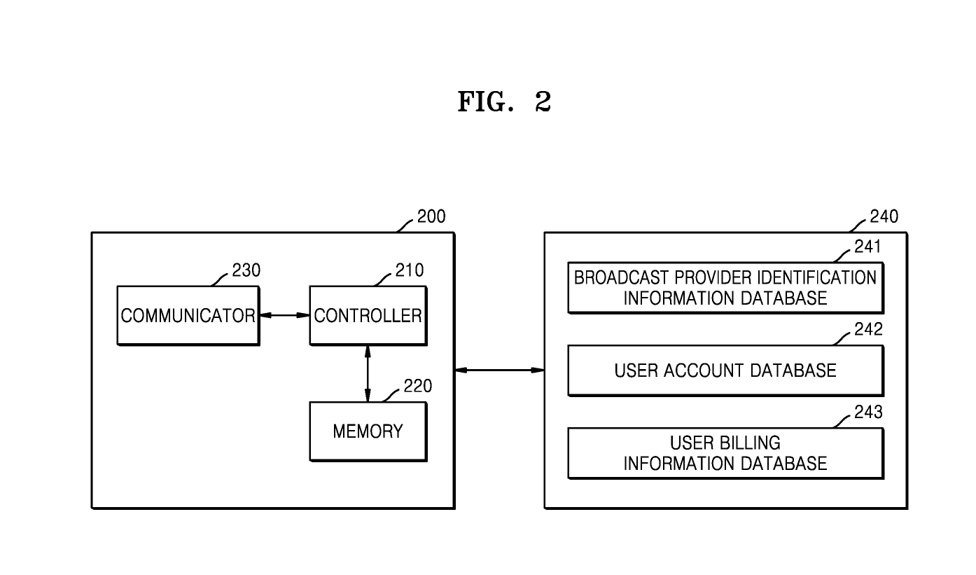

FIG. 2 is a block diagram of the broadcast service management server 200 according to an embodiment.

Referring to FIG. 2, the broadcast service management server 200 includes a controller 210, a memory 220, and a communicator 230.

The communicator 230 communicates with the client 100 and the broadcast provider server 300 over the network 50.

The memory 220 stores an operating system and one or more instructions.

The controller 210 includes one or more processors to generally control components in the broadcast service management server 200. The controller 210 may perform one or more functions by performing the one or more instructions stored in the memory 220.

According to an embodiment, the controller 210 may provide the client 100 with identification information about one or more broadcast provider servers available to the client 100 according to a request of the client 100.

According to an embodiment, the controller 210 may provide a key for authenticating the client 100 or perform authentication of the client 100 according to a request from the client 100 or the broadcast provider server 300.

According to an embodiment, the controller 210 may collect billing information about use of a broadcast service from the client 100 and provide the collected billing information to the client 100 or the broadcast provider server 300.

According to an embodiment, the broadcast service management server 200 may operate a database 240 including a broadcast provider identification information database 241 for storing identification information about one or more broadcast provider servers, a user account database 242 for storing information about authentication of the client 100, and a user billing information database 243 for storing billing information of the client 100 as a separate server or may place the database 240 in the broadcast service management server 200.

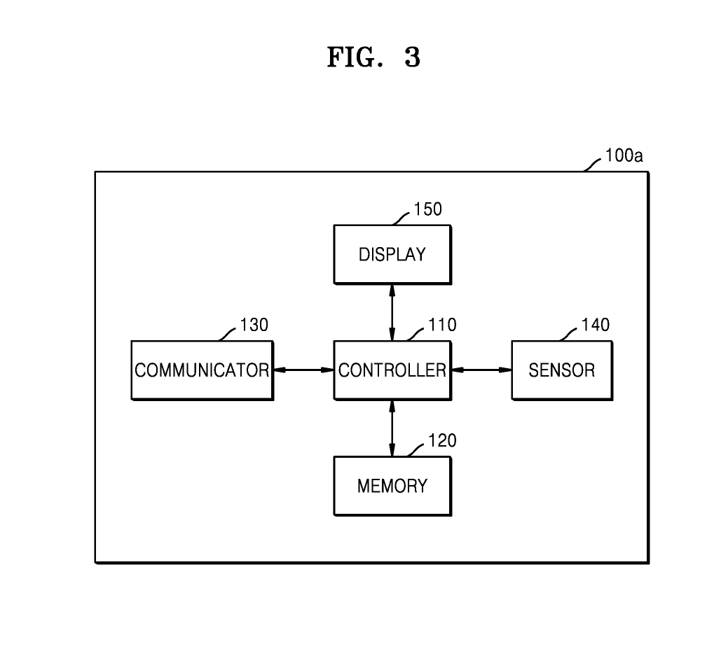

FIG. 3 illustrates a client device 100a which is an example of the client 100 according to an embodiment.

Referring to FIG. 3, the client device 100a includes a controller 110, a memory 120, a communicator 130, a sensor 140, and a display 150.

The memory 120 may store various data, programs or applications for driving and controlling the client device 100a under the control of the controller 110. The memory 120 may include non-volatile memory, volatile memory, a hard disk drive (HDD), or a solid state drive (SSD).

The communicator 130 performs communication with the broadcast service management server 200 and the one or more broadcast provider servers 300. The communicator 130 may include one or a combination of wireless LAN, Bluetooth, and wired Ethernet corresponding to the performance and structure of the client 100. The communicator 130 may further include a tuner for receiving a broadcast signal in a frequency band corresponding to a channel number according to user input.

The sensor 140 may sense a user's voice, an image of a user, or an interaction of the user, and may include a microphone, a camera, and a light receiver. The light receiver may receive an optical signal (including a control signal) received from an external control device.

The display 150 may display one or more user interfaces for displaying broadcast contents received through the communicator 130 or receiving a user selection. The one or more user interfaces may include a user interface for selecting a broadcast provider, a user interface for selecting a contents policy of the broadcast provider, and various menu interfaces provided by the broadcast service management server 200.

The controller 110 includes one or more processors to perform functions of controlling a signal flow between components in the client device 100a and processing data.

According to an embodiment, in response to transmitting of information capable of identifying a location of the client device 100a to the broadcast service management server 200 over a network, the controller 110 may receive identification information of one or more broadcast providers available to the client device 100a from the broadcast service management server 200, display a user interface including the received identification information of one or more broadcast providers, receive a user input to select one broadcast provider from the identification information of one or more broadcast providers through the user interface, in response to the received user input, access the selected broadcast provider server, and receive and store CAS software from the broadcast provider server.

According to an embodiment, the controller 110 may access the selected broadcast provider server according to a user input, display a user interface including one or more contents providing policies received in response to receiving of the one or more contents providing policies from the broadcast provider server, transmit a selected contents providing policy from the one or more contents providing policies through the user interface to the broadcast provider server, and receive and store CAS software corresponding to the selected contents providing policy from the broadcast provider server.

According to an embodiment, the controller 110 may receive a user input to select another broadcast provider server, accesses the other selected broadcast provider server in response to the received user input, and receive and store other CAS software from the other broadcast provider server.

According to an embodiment, when storing the other CAS software, the controller 110 may remove previously stored CAS software.

According to an embodiment, when storing the other CAS software, the controller 110 may store the other CAS software together without removing the previously stored CAS software.

According to an embodiment, the controller 110 may enable and use one of the stored CAS software and the other CAS software according to selection of the user of the broadcast provider server.

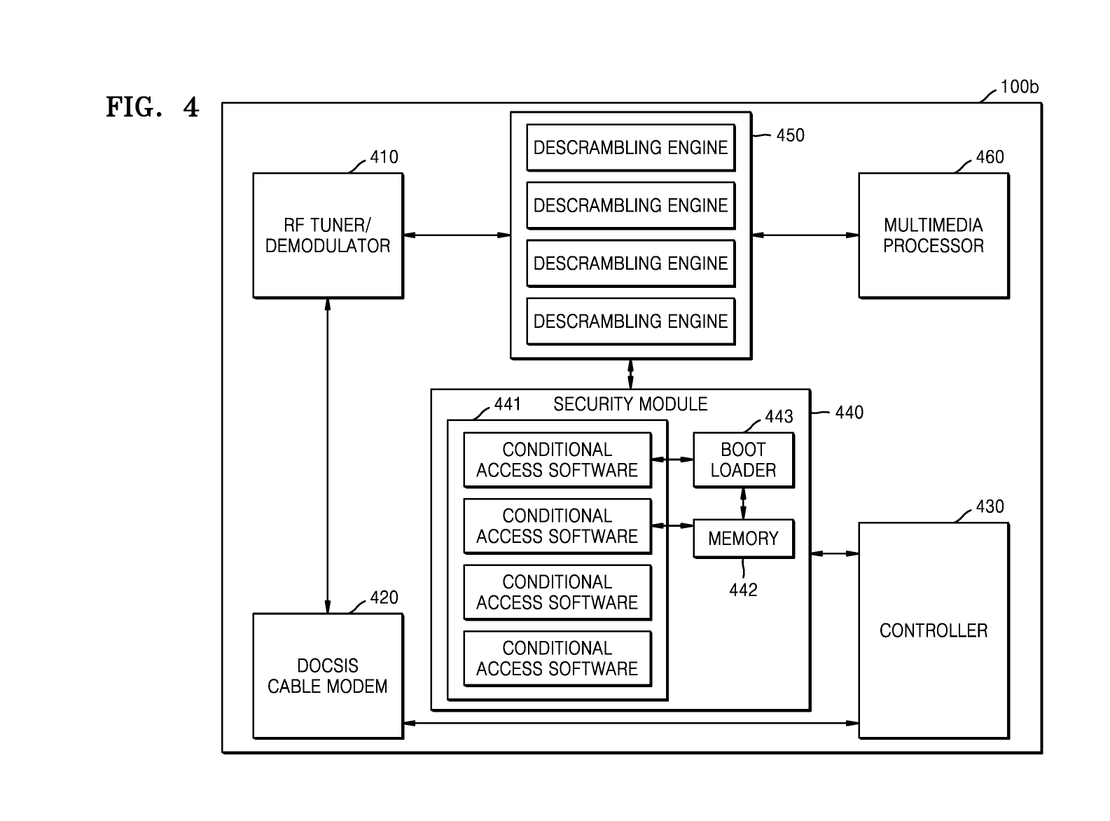

FIG. 4 illustrates a client device 100b which is an example of the client 100 according to an embodiment.

Referring to FIG. 4, the client device 100b includes an RF tuner/demodulator 410, a DOCSIS cable modem 420, a controller 430, a security module 440, a transport stream processor 450, and a multimedia processor 460.

The RF tuner/demodulator 410 converts a broadcast signal received over a cable network into scrambled A/V data through a baseband signal conversion and demodulation process.

The DOCSIS cable modem 420 securely downloads CAS software by performing a mutual authentication and encryption key sharing process based on a DCAS protocol over a bidirectional communication channel.

The security module 440 is a security chip embedded in the client device 100b and provides an environment in which security module firmware supporting mutual authentication of a broadcast provider server and a subscriber device, downloading of the DCAS protocol and a CAS client, etc. and downloaded client programs may be securely stored and driven.

The security module 440 establishes a stable communication channel with the broadcast provider server through mutual authentication based on the DCAS protocol and securely stores downloaded conditional access software in a security region 441 through the communication channel. To this end, the security module 440 supports an encryption algorithm for the mutual authentication and encryption key sharing process with the broadcast provider server. Also, the security module 440 includes various security functions for protecting a boot loader 443 and the conditional access software operating in the security module 440 from external physical hacking.

According to an embodiment, the security region 441 may download and store one or more conditional access software.

According to an embodiment, the security region 441 may download and store one or more CAS software corresponding to one or more broadcast providers under the control of the controller 430.

According to an embodiment, the security region 441 may enable, disable, or remove some of the stored one or more CAS software under the control of the controller 430.

The boot loader 443 loads and drives one of plurality of conditional access software stored in the security region 441 into a memory 442.

The transport stream processor 450 has a function of descrambling an input broadcast signal according to whether the input broadcast signal is scrambled and a viewing right of a subscriber. The transport stream processor 450 may include descrambling engines respectively corresponding to a plurality of algorithms to support a plurality of CASs. For example, the plurality of algorithms includes MPEG-2 TS, DVB-CSA, AES (Advanced Encryption Standard)-128, DES (Data Encryption Standard), 3-DES, CSA (Common Scrambling Algorithm), etc. and has a reconfigurable structure such that a specific CAS desired by a broadcast service provider may be freely selected. The transport stream processor 450 may receive key information, a control word, encryption algorithm information, etc. necessary for descrambling from the CAS client driven by the security module 440, and descramble the scrambled signal using the key information, the control word, the encryption algorithm information, etc.

The multimedia processor 460 converts the signal received from the transport stream processor 450 into an A/V signal using a suitable decoder, for example, an MPEG decoder, and outputs the A/V signal.

The controller 430 generally controls components in the client device 100b.

According to an embodiment, the controller 430 may control the security region 441 to store the CAS software corresponding to one or more broadcast providers based on a user input.

According to an embodiment, the controller 430 may control the security region 441 to enable, disable, or remove some of the one or more CAS software stored in the security region 441 based on a user input.

The configuration shown in FIG. 4 is a block of a client in terms of processing for storing the CAS software. The configuration shown in FIG. 4 that is functionally equivalent to the configuration shown in FIG. 3 may correspond to each other.

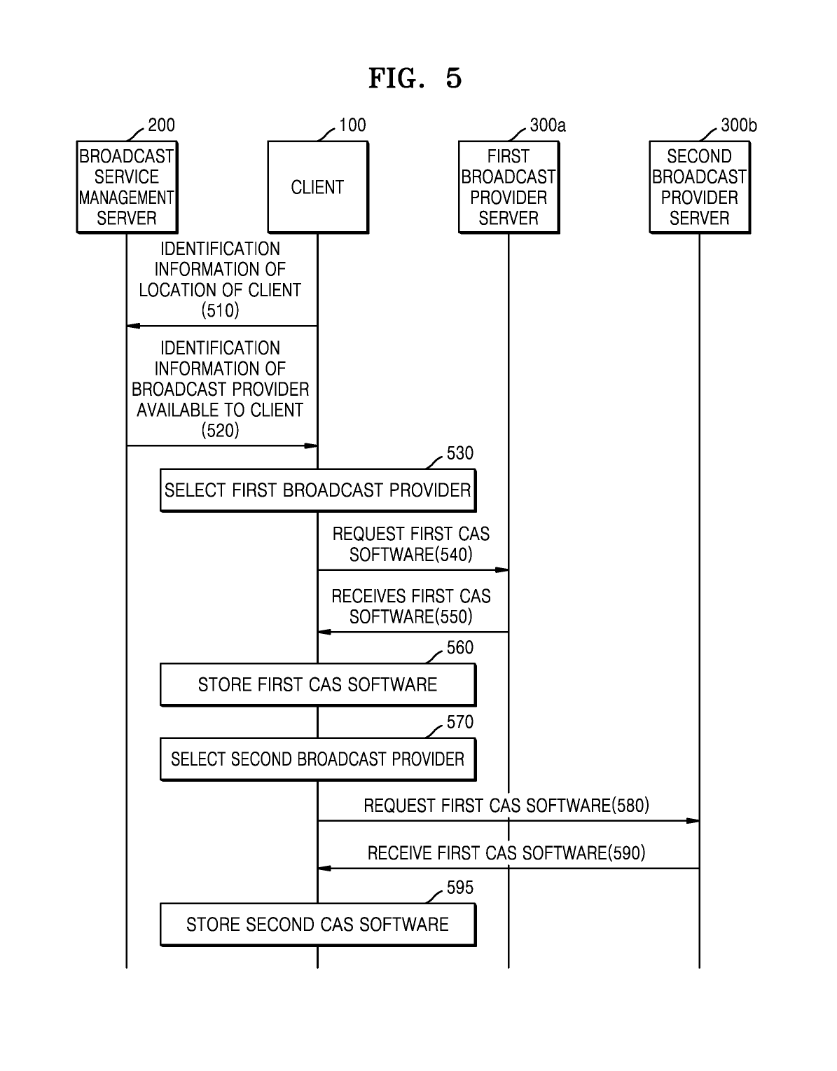

FIG. 5 is a flowchart illustrating an example of an operation in a broadcast service providing system according to an embodiment.

Referring to FIG. 5, in operation 510, the client 100 may transmit location identification information of the client 100 to the broadcast service management server 200. It is preferable to provide the location identification information of the client 100 because a broadcast provider available to the client 100 differs according to a region where the client 100 is installed. For example, a service providing broadcast provider may differ for each region such as, in a region A, first to fifth broadcast providers provide broadcast services, while in a region B, third to sixth broadcast providers provide broadcast services.

According to an embodiment, the client 100 may transmit to the broadcast service management server 200 information identifying a location of the client 100 such as local information input by a user or IP information set in the client 100 at the time of initialization of the client 100.

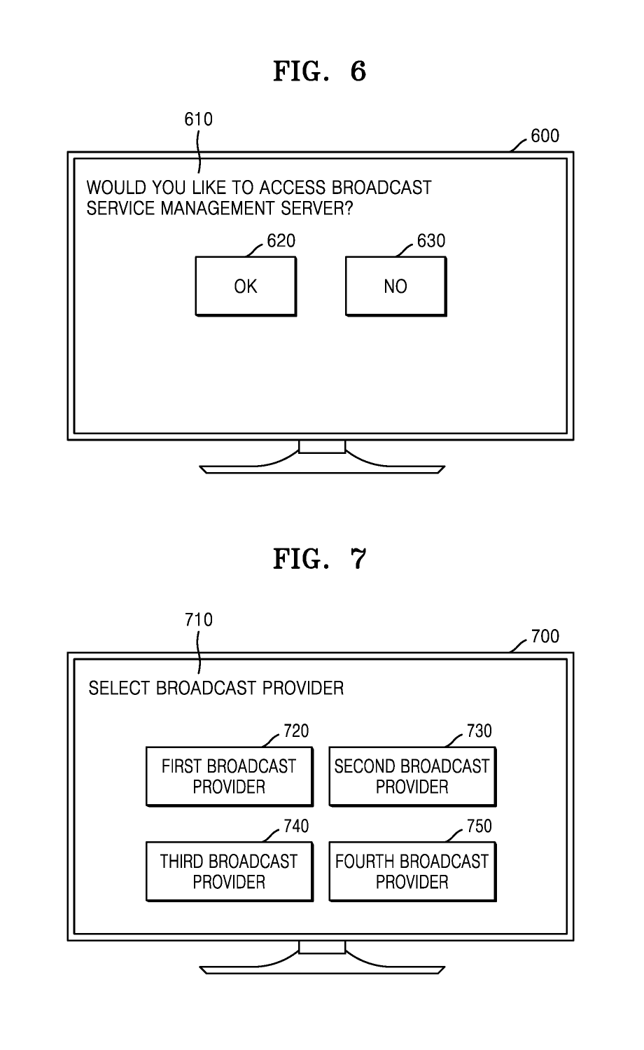

For example, when the client 100 provides a user interface 600 as shown in FIG. 6 at the time of initialization of the client 100, and the user selects an <OK> item 620 in response to an item 610 <Would you like to access broadcast service management server>, the client 100 may access the broadcast service management server 200 and transmit the information identifying the location of the client 100 to the broadcast service management server 200.

In operation 520, the broadcast service management server 200 may transmit broadcast provider identification information 520 available to the client 100 to the client 100.

Based on the location identification information of the client 100 received from the client 100, the broadcast service management server 200 searches for one or more broadcast provider identification information that the client 100 may use and transmits the found one or more broadcast provider identification information to the client 100. The broadcast provider identification information may be in any form as long as it is information that may identify a broadcast provider. For example, the broadcast provider identification information may include an URL of the broadcast provider.

In operation 530, the client 100 receives the one or more broadcast provider identification information from the broadcast service management server 200, and selects one of one or more broadcast providers.

For example, when the client 100 receives the one or more broadcast provider identification information from the broadcast provider management server 200, the client 100 may provide a user interface 700 as shown in FIG. 7, and output broadcast provider identification information 710 to 750 with an item 710 <Select broadcast provider>. The user may select one broadcast provider item from the first broadcast provider item 720 to the fourth broadcast provider item 750 displayed on the user interface 700.

In operation 540, the client 100 may request CAS software to the broadcast provider server selected by the user. For example, when the user selects a first broadcast provider, the client 100 may request first broadcast provider server software operated by a first broadcast provider server from a first broadcast provider server 300a.

In operation 550, the first broadcast provider server 300a may transmit first CAS software to the client 100 and the client 100 may receive the first CAS software.

In operation 560, the client 100 may securely store the first CAS software received from the first broadcast provider server 300a in the security region 441 of a security chip inside the client 100. To perform operations 540 to 560 of FIG. 5, the client 100 and the first broadcast provider server 300a may establish a stable communication channel with a broadcast provider server through mutual authentication based on a DCAS protocol, and securely download CAS software through the communication channel.

In operation 570, the client 100 may further select a second broadcast provider.

In operation 580, the client 100 may request second CAS software operated by a second broadcast provider server 300b from the second broadcast provider server 300b selected by the user.

In operation 590, when the second broadcast provider server 300b transmits the second CAS software to the client 100, the client 100 may receive the second CAS software.

In operation 595, the client 100 may securely store the second CAS software received from the second broadcast provider server 300b in a secure region of the client 100. To perform operations 580 to 595 of FIG. 5, the client 100 and the second broadcast provider server 300b may establish a stable communication channel with the broadcast provider server through mutual authentication based on the DCAS protocol, and securely download CAS software through the communication channel.

According to an embodiment, the client 100 may remove the previously stored first CAS software and store the second CAS software.

According to an embodiment, the client 100 may store the second CAS software together with the first CAS software without removing the previously stored first CAS software.

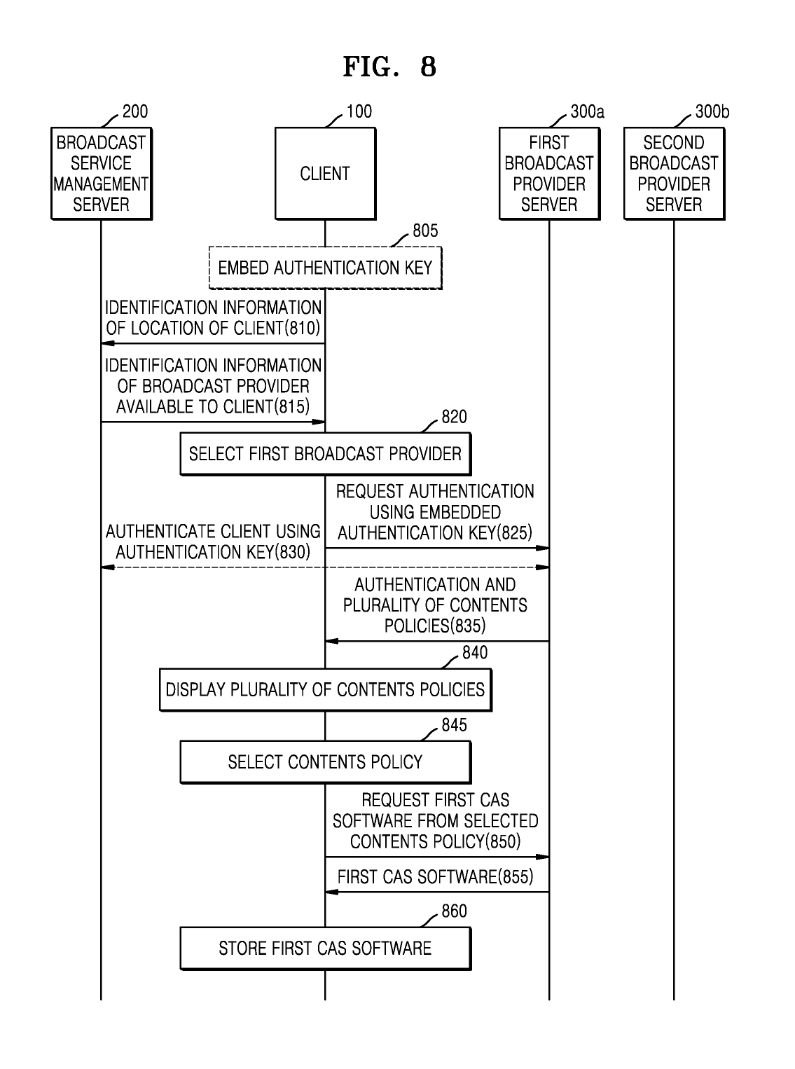

FIG. 8 is a flowchart illustrating another example of an operation in a broadcast service providing system according to an embodiment.

Referring to FIG. 8, in operation 805, the client 100 has an authentication key embedded therein. A client manufacturer may store the authentication key inside a client device when manufacturing the client device.

In operation 810, when the client 100 transmits location identification information of the client 100 to the broadcast service management server 200, in operation 815, the broadcast service management server 200 may transmit one or more broadcast provider identification information available to the client 100 to the client 100.

In operation 820, when a user of the client 100 selects the first broadcast provider, and in operation 825, the client 100 may request authentication from the first broadcast provider server 300a using the embedded authentication key.

In operation 830, the first broadcast provider server 300a receiving an authentication request may request the broadcast service management server 200 to authenticate the client 100 using the authentication key received from the client 100, and receive authentication.

In operation 835, the first broadcast provider server 300a may transmit an authentication result and a plurality of contents policies provided by the first broadcast provider server 300a to the client 100.

In operation 840, the client 100 may receive the plurality of contents policies from the first broadcast provider server 300a and provide a user interface for receiving a selection of one of the plurality of contents policies.

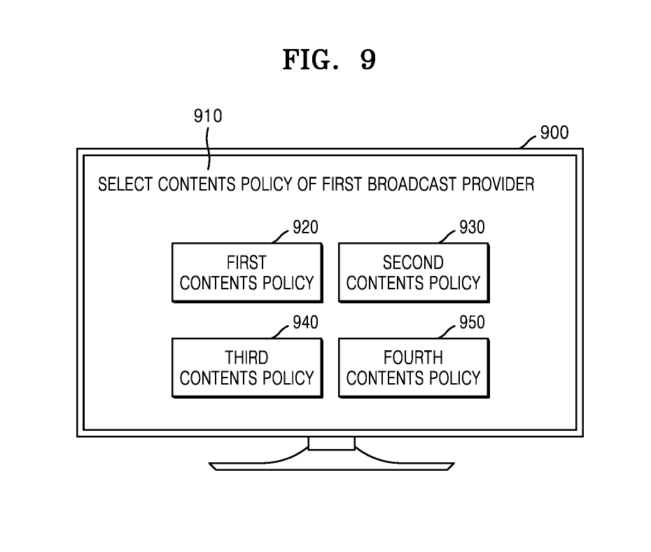

For example, the client 100 may provide a user interface 900 as shown in FIG. 9, and display a first contents policy 920 to a fourth contents policy 950 with an item 910 <Selection of contents policy of first broadcast provider>. A user may select one of the first contents policy 910 to the fourth contents policy 950 displayed on the user interface 900.

In operation 845, the client 100 receives selection of one contents policy from the user. In operation 850, the client 100 may request first CAS software corresponding to the selected contents policy.

In operation 855, the first broadcast provider server 300a may transmit the first CAS software requested from the client 100 to the client 100.

In operation 860, the client 100 may store the received first CAS software in a secure region.

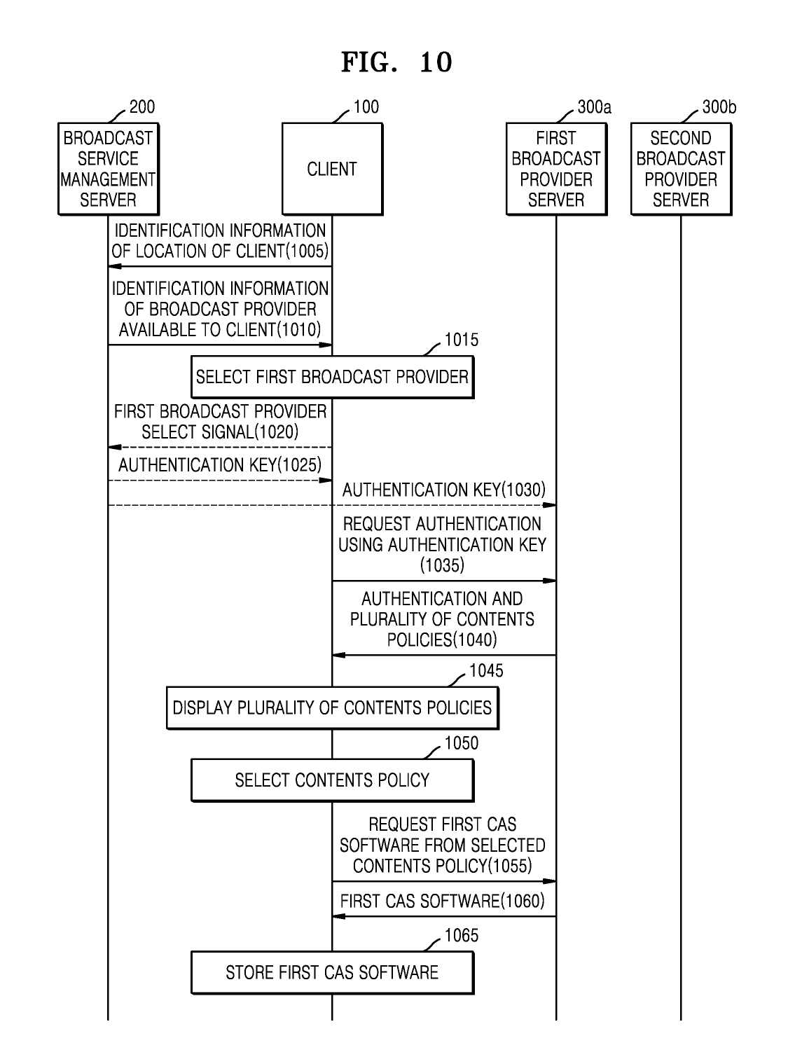

FIG. 10 is a flowchart illustrating another example of an operation in a broadcast service providing system according to an embodiment.

Referring to FIG. 10, in operation 1005, the client 100 may transmit location identification information of the client 100 to the broadcast service management server 200.

In operation 1010, the broadcast service management server 200 may transmit to the client 100 one or more broadcast provider identification information available to the client 100.

In operation 1015, when a user of the client 100 selects one broadcast provider from the one or more broadcast provider identification information, and in operation 1020, the client 100 may transmit a signal indicating that a first broadcast provider is selected to the broadcast service management server 200.

In operation 1025, when the broadcast service management server 200 receives the first broadcast provider selection signal of the client 100, the broadcast service management server 200 may generate an authentication key of the client 100 and transmit the generated authentication key to the client 100.

In operation 1030, the broadcast service management server 200 may also transmit an authentication key for authentication of the client 100 to the first broadcast provider server 300a.

In operation 1035, the client 100 may request authentication from the first broadcast provider server 300a using the authentication key received from the broadcast service management server 200.

In operation 1040, the first broadcast provider server 300a receiving an authentication request from the client 100 authenticates the client 100 using the authentication key received from the client 100 and the authentication key received from the broadcast service management server 200, and transmit an authentication result and a plurality of contents policies to the client 100.

In operation 1045, the client 100 may receive the plurality of contents policies from the first broadcast provider server 300a and provide a user interface for receiving a selection of one of the plurality of contents policies.

In operation 1050, the client 100 receives the selection of one contents policy from the user. In operation 1055, the client 100 may request first CAS software corresponding to the selected contents policy.

In operation 1060, the first broadcast provider server 300a may transmit the first CAS software requested from the client 100 to the client 100.

In operation 1065, the client 100 may store the received first CAS software in a secure region.

According to the embodiments, as described with reference to FIG. 5, a user of the client 100 may select a plurality of broadcast providers and download CAS software corresponding to each of the plurality of broadcast providers in the client 100.

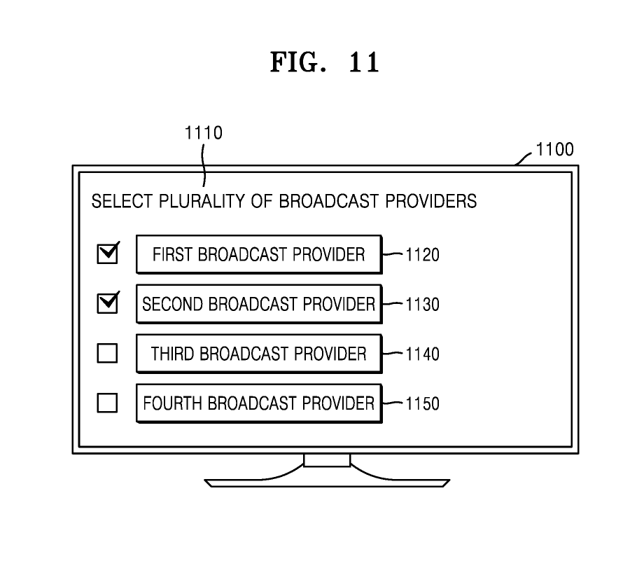

According to an embodiment, the user of the client 100 may enable one or more CAS software among the plurality of CAS software downloaded in the client 100 to receive contents from one or more broadcast providers. FIG. 11 illustrates an example of a user interface 1100 for selecting a plurality of broadcast providers according to an embodiment.

Referring to FIG. 11, the client 100 may display the user interface 1100 for selecting the plurality of broadcast providers corresponding to a plurality of CAS software stored in a secure region of the client 100.

The user interface 1100 may display first to fourth broadcast provider items 1120 to 1150 with an item 1110 <select plurality of broadcast providers>. When receiving an input from a user to select, for example, the first broadcast provider item 1120 and the second broadcast provider item 1130, the client 100 may enable CAS software corresponding to a first broadcast provider and CAS software corresponding to a second broadcast provider among the CAS software corresponding to the plurality of broadcast providers stored in the client 100.

By enabling one or more CAS software in the client 100, the user may receive contents from the plurality of broadcast providers, rather than receiving contents provided by only one broadcast provider. For example, as shown in FIG. 11, when the user selects the first broadcast provider and the second broadcast provider, the user may receive both contents of the first broadcast provider and contents of the second broadcast provider.

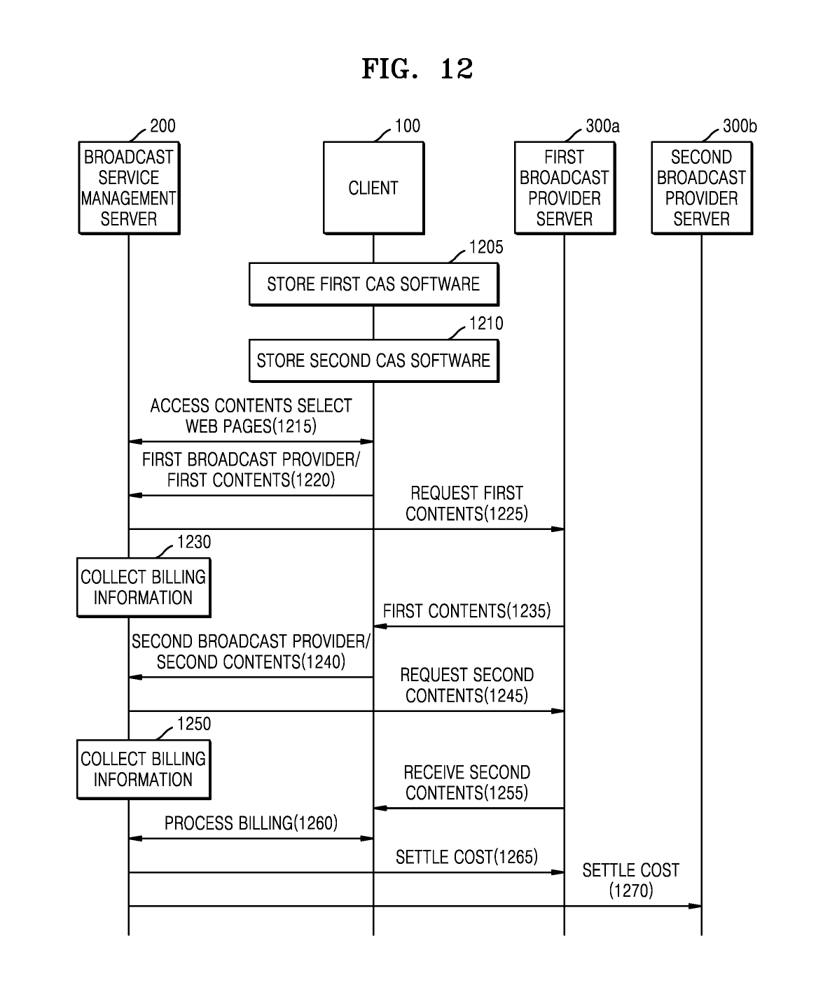

FIG. 12 illustrates an example of a billing process operation performed in the broadcast service management server 200 according to an embodiment.

Referring to FIG. 12, in operation 1205, the client 100 may store first CAS software of a first broadcast provider server and, in operation 1210, store second CAS software of a second broadcast provider server.

In operation 1215, the client 100 may access the broadcast service management server 200 for contents selection. That is, when the client 100 accesses the broadcast service management server 200, the broadcast service management server 200 may provide a web page for contents selection, etc. to the client 100.

In operation 1220, a user of the client 100 may select first broadcast provider/first contents.

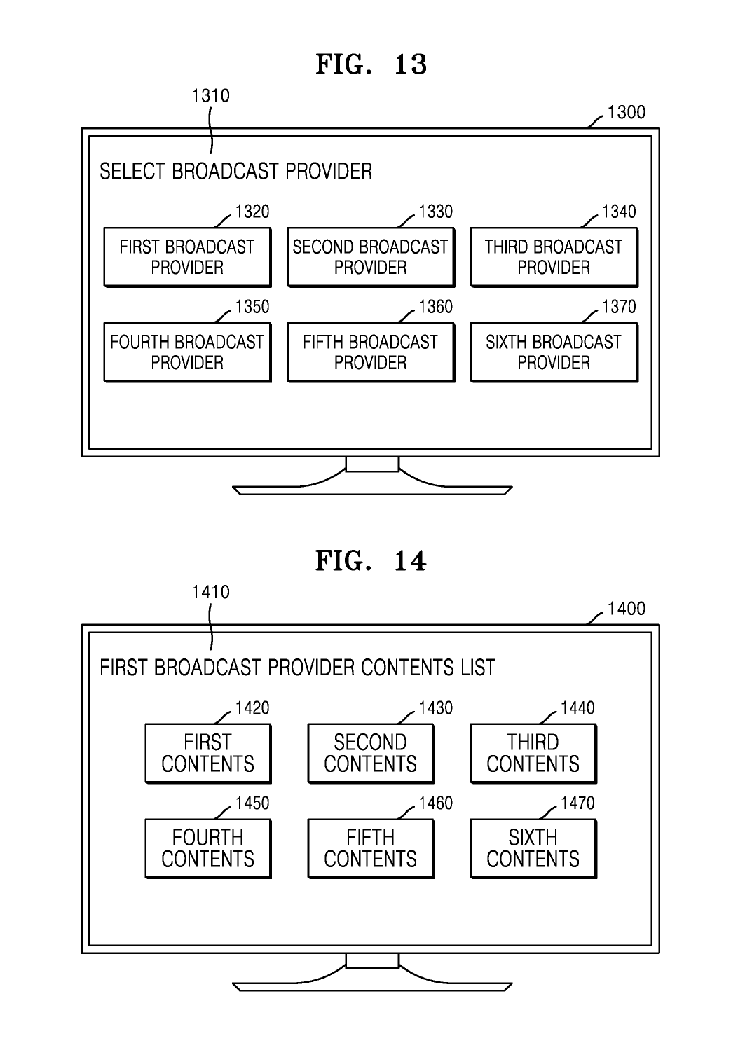

For example, a display of the client 100 may display a user interface 1300 as shown in FIG. 13. Referring to FIG. 13, the user interface 1300 may display a plurality of broadcast provider items, that is, a first broadcast provider item 1320 and a second broadcast provider item 1330 with an item 1310 <Select broadcast provider>. The broadcast provider items displayed on the user interface 1300 may be a broadcast provider corresponding to CAS software enabled by the user. For example, broadcast provider information corresponding to the CAS software enabled by the user in the client 100 may be provided to the broadcast service management server 200. The broadcast service management server 200 may provide the client 100 with one or more broadcast provider information corresponding to the enabled one or more CAS software received from the client 100.

In response to the user selecting, for example, the first broadcast provider item 1320 on the user interface 1300 shown in FIG. 13 and transmitting a selection signal to the broadcast service management server 200, the broadcast service management server 200 may transmit a page as shown in FIG. 14. That is, the client 100 may display a user interface 1400 that allows the user to select one from a contents list of the first broadcast provider. The user interface 1400 may display a first contents item 1420 to a sixth contents item 1470 with a first broadcast provider contents list item 1410.

The broadcast service management server 200 receiving a signal indicating that the user selects the first contents item 1420 on the user interface 1400 shown in FIG. 14 from the client 100 may request the first broadcast provider server 300a to transmit the first contents requested by the user to the client 100 in operation 1225.

In operation 1230, the broadcast service management server 200 may collect billing information about a first contents item of the first broadcast provider server 300a.

In operation 1235, the first broadcast provider server 300a may transmit requested first contents to the client 100.

In operation 1240, the client 100 may similarly transmit a signal to select second contents provided by a second broadcast provider to the broadcast service management server 200.

In operation 1245, the broadcast service management server 200 may request the second broadcast provider server 300b to transmit the second contents requested by the user to the client 100.

In operation 1250, the broadcast service management server 200 may collect billing information about a second contents item of the second broadcast provider server 300b. Amounts charged for each broadcast provider among a plurality of broadcast providers and for each contents among a plurality of contents may be different.

In operation 1255, the second broadcast provider server 300b may transmit the requested second contents to the client 100.

In operation 1260, the broadcast service management server 200 may integrate the collected billing information and proceed with a billing process with the client 100. For example, when an amount of contents consumed by the client 100, that is, the amount of the first contents of the first broadcast provider is 1000 KRW and an amount of the second contents of the second broadcast provider is 2000 KRW, the broadcast service management server 200 may determine 3,000 KRW as a final amount to be charged to the client 100. The broadcast service management server 200 may proceed with the billing processing for the final amount of 3000 KRW with the client 100.

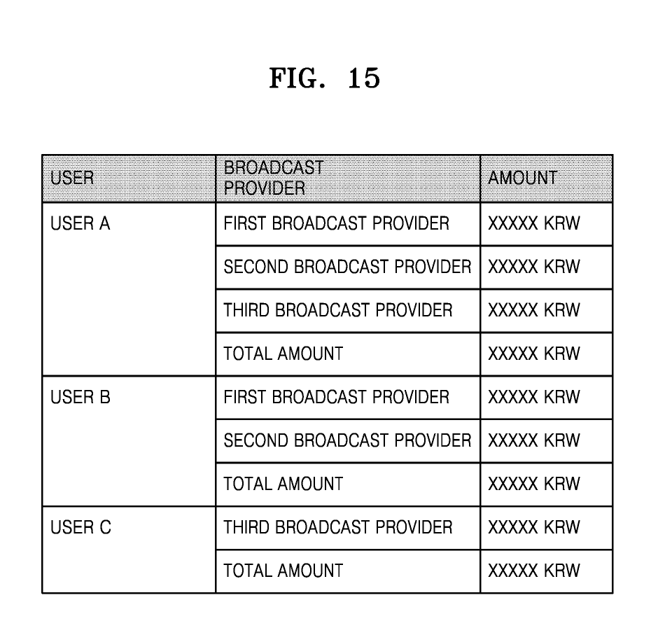

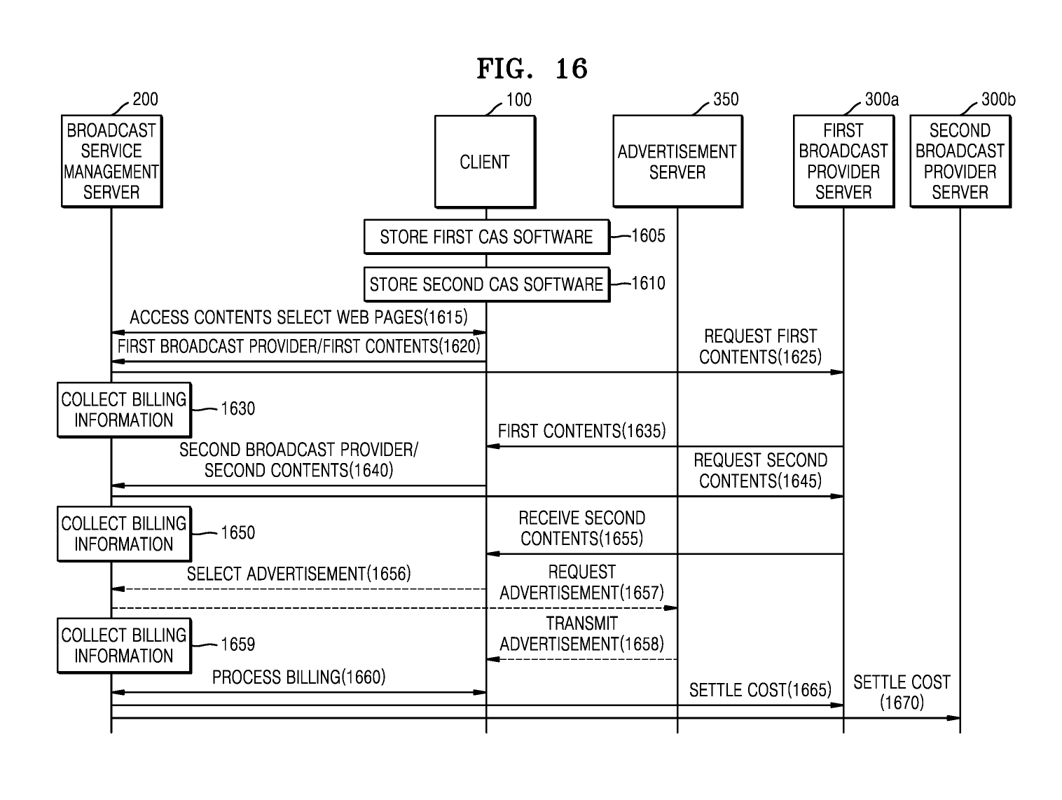

For example, as shown in FIG. 15, the broadcast service management server 200 may generate billing information for each user by the contents of a broadcast provider used by each user. For example, referring to FIG. 15, a user A uses contents from a first broadcast provider, a second broadcast provider, and a third broadcast provider, and the broadcast service management server 200 may charge the total amount to the user A. A user B may use the contents from the first broadcast provider and the second broadcast provider and the broadcast service management server 200 may charge the total amount to the user B. A user C uses the contents from the third broadcast provider and the broadcast service management server 200 may charge the total amount to the user C.

In operation 1265 and operation 1270, the broadcast service management server 200 may settle a first contents usage amount of the first broadcast provider server 300a and a second contents usage amount of the second broadcast provider server 300b.

The broadcast service management server 200 may not only provide contents of a broadcast provider to a user but also provide an advertisement to the user using an advertisement server by using a broadcast provider server. The broadcast service management server 200 may reduce a contents usage amount as an advertisement viewing fee by allowing the user to view the advertisement by providing the advertisement of the advertisement server. By thus attracting advertisements to consumption of the contents, advertisers may provide advertisements to more users, and users may use the contents at a lower cost. Also, broadcast providers may encourage users to use more contents through advertisements, thereby increasing the consumption of the contents.

FIG. 16 illustrates another example of a billing process operation performed in the broadcast service management server 200 according to an embodiment.

The operation shown in FIG. 16 is similar to the operation shown in FIG. 12 except that the operation shown in FIG. 16 further includes operations 1656 to 1658 of providing an advertisement from an advertisement server 350 to a user and using advertisement viewing information for collecting billing information.

Referring to operation 1656, the client 100 may access the broadcast service management server 200 and select advertisement viewing.

In operation 1657, the broadcast service management server 200 may request the advertisement server 350 which provides an advertisement selected by the user to provide an advertisement to the client 100.

In operation 1658, the advertisement server 350 may transmit the requested advertisement to the client 100.

In operation 1659, the broadcast service management server 200 may collect the billing information of the client 100. At this time, the broadcast service management server 200 may generate the billing information in consideration of a reward for viewing the advertisement of the client 100. For example, the broadcast service management server 200 may deduct an amount corresponding to advertisement viewing from a contents usage amount to be charged to the user in exchange for the user watching the advertisement. According to embodiments, the reward may be increased by a viewing time of the advertisement. Alternatively, when there are a plurality of advertisements, the reward may be set differently for each advertisement.

For example, when the user uses contents of about 30,000 KRW in total and watches an advertisement of 5,000 KRW, the broadcast service management server 200 may charge 25,000 KRW to the user as a contents usage fee.

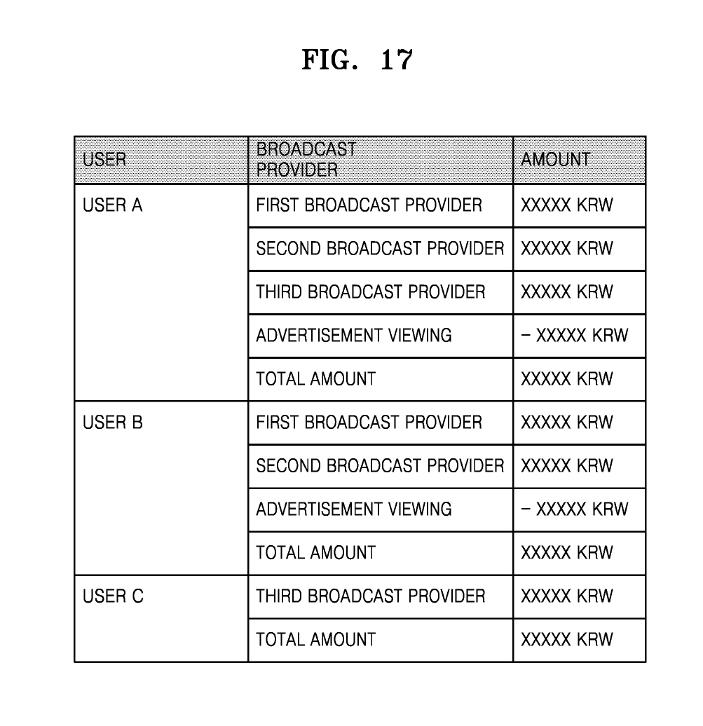

Referring to FIG. 17, a total contents usage fee for the user A may be determined as contents usage amount of a first broadcast provider used by the user A+a contents usage amount of a second broadcast provider+a contents usage amount of a third broadcast provider—a reward amount corresponding to the advertisement viewing. This is the same for other users.

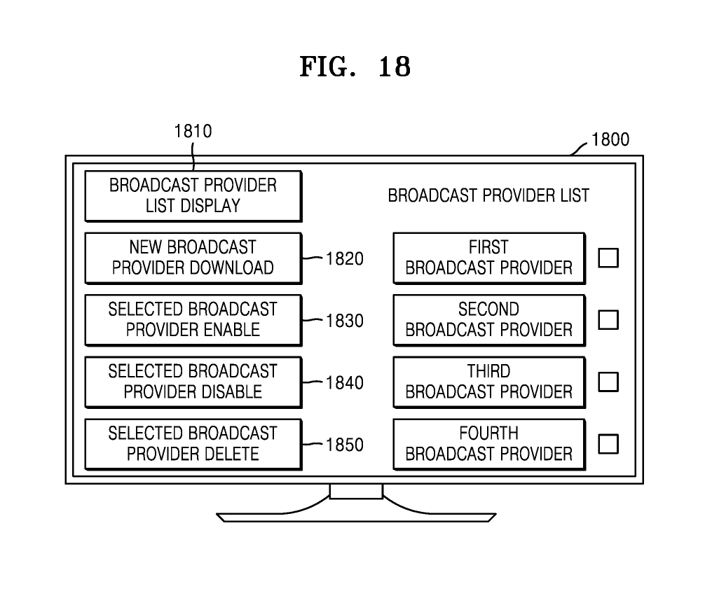

FIG. 18 illustrates an example of a user interface 1800 for allowing the client 100 to manage a plurality of broadcast providers according to an embodiment.

Referring to FIG. 18, the user interface 1800 may include a broadcast provider list display item 1810, a new broadcast provider download item 1820, a selected broadcast provider enable item 1830, a selected broadcast provider disable item 1840, and a selected broadcast provider delete item 1850.

In response to a user input to select the broadcast provider list display item 1810, the client 100 may display one or more broadcast provider lists 1860 corresponding to one or more CAS software stored in the client 100 on a display.

In response to a user input to select the new broadcast provider download item 1820, the client 100 may output the user interface 700 for selecting a broadcast provider as shown in FIG. 7.

In response to a user input to select the selected broadcast provider enable item 1830, the client 100 may enable one or more CAS software of a plurality of CAS software stored in the client 100. For example, according to a user input to check one or more broadcast providers of the plurality of broadcast providers displayed on the broadcast provider lists 1860 and select the broadcast provider enable item 1830, the client 100 may enable the CAS software corresponding to the checked broadcast providers.

In response to a user input to select the selected broadcast provider disabled item 1840, the client 100 may disable one or more CAS software of a plurality of CAS software stored in the client 100.

In response to the user input to select the selected broadcast provider deletion item 1850, the client 100 may remove the CAS software corresponding to a selected broadcast provider from among the plurality of CAS software stored in the client 100, from a security module.

The operation method of the electronic device according to an embodiment may also be embodied as programmed commands to be executed in various computer units, and then may be recorded in a computer-readable recording medium. The computer-readable recording medium may include one or more of the programmed commands, data files, data structures, or the like. The programmed commands recorded to the computer-readable recording medium may be particularly designed or configured for the present disclosure or may be well known to one of ordinary skill in the art. Examples of the computer-readable recording medium include magnetic media including hard disks, magnetic tapes, and floppy disks, optical media including CD-ROMs and DVDs, magneto-optical media including floptical disks, and hardware designed to store and execute the programmed commands in ROM, RAM, a flash memory, and the like. Examples of the programmed commands include not only machine code generated by a compiler but also include a high-level programming language to be executed in a computer by using an interpreter.

While the embodiments have been particularly described, the spirit and scope of the disclosure may also include various changes and improvements in form and details which are made by those of ordinary skill in the art, in view of a basic concept of the disclosure as defined by the appended claims.

1. An electronic device comprising:
a communicator;
a memory storing one or more instructions; and
a processor configured to execute the one or more instructions stored in the memory to:
in response to transmitting information for identifying a location of the electronic device to a broadcast service management server over a network, receive identification information about one or more broadcast providers available to the electronic device from the broadcast service management server:
display a user interface comprising the received identification information about the one or more broadcast providers, and receive a user input to select one broadcast provider from the identification information about the one or more broadcast providers through the user interface; and
in response to the received user input, access the selected broadcast provider and receive conditional access system (CAS) software from the broadcast provider.

2. The electronic device of claim 1, wherein the processor is further configured to execute the one or more instructions to:
access the broadcast provider selected according to the user input;
in response to receiving one or more content providing policies from the broadcast provider, display a user interface comprising the received one or more content providing policies;
transmit a content providing policy selected from the one or more content providing policies to the broadcast provider through the user interface; and
receive and store the CAS software corresponding to the selected content providing policy from the broadcast provider.

3. The electronic device of claim 1, wherein the processor is further configured to execute the one or more instructions to:
receive a user input to select another broadcast provider;
in response to the received user input, access the selected other broadcast provider and receive and store other CAS software from the other broadcast provider.

4. The electronic device of claim 3, wherein the processor is further configured to execute the one or more instructions to: when storing the other CAS software, remove previously stored CAS software.

5. The electronic device of claim 3, wherein the processor is further configured to execute the one or more instructions to: when storing the other CAS software, store the other CAS software without removing the previously stored CAS software.

6. The electronic device of claim 5, wherein the processor is further configured to execute the one or more instructions to: enable one of the stored CAS software and the other CAS software according to a user input to select a broadcast provider.

7. A system for providing a broadcast service, the system comprising:
a broadcast service management server configured to provide a client device with identification information about one or more broadcast providers available to the client device in correspondence to a location of the client device, and in response to a user input to select one of the one or more broadcast providers, provide the client device with information of the selected broadcast provider;
the client device configured to send a request for conditional access system (CAS) software of the broadcast provider to the broadcast provider using the information of the broadcast provider received from the broadcast service management server and receive and store the conditional access system (CAS) software from the broadcast provider; and
one or more broadcast providers configured to provide the CAS software to the client device upon request by the client device.

8. An operation method of an electronic device, the operation method comprising:
in response to transmitting information for identifying a location of the electronic device to a broadcast service management server over a network, receiving identification information about one or more broadcast providers available to the electronic device from the broadcast service management server:
displaying a user interface comprising the received identification information about the one or more broadcast providers and receiving a user input to select one broadcast provider from the identification information about the one or more broadcast providers through the user interface; and
in response to the received user input, accessing the selected broadcast provider and receiving conditional access system (CAS) software from the broadcast provider.

9. The operation method of claim 8, further comprising:
accessing the broadcast provider selected according to the user input;
in response to receiving one or more content providing policies from the broadcast provider, displaying a user interface comprising the received one or more content providing policies;
transmitting a content providing policy selected from the one or more content providing policies to the broadcast provider through the user interface; and
receiving and storing the CAS software corresponding to the selected content providing policy from the broadcast provider.

10. The operation method of claim 8, further comprising:
receiving a user input to select another broadcast provider;
in response to the received user input, accessing the selected other broadcast provider; and
receiving and storing other CAS software from the other broadcast provider.

11. The operation method of claim 10, further comprising: when storing the other CAS software, removing previously stored CAS software.

12. The operation method of claim 10, further comprising: when storing the other CAS software, storing the other CAS software without removing the previously stored CAS software.

13. The operation method of claim 12, further comprising: enabling one of the stored CAS software and the other CAS software according to a user input to select a broadcast provider.

14. A computer-readable recording medium having recorded thereon a program for executing the operation method of an electronic device according to claim 8.
